(19) United States
(12) Patent Application Publication
(10) Pub. No.: US 2014/0158466 A1
(43) Pub. Date: Jun. 12, 2014

(54) SWIMMING POOL LADDER

(71) Applicants: MARKUS HUBER, Chesapeake, VA (US); DAVID MCNALLY, Virginia Beach, VA (US)

(72) Inventors: MARKUS HUBER, Chesapeake, VA (US); DAVID MCNALLY, Virginia Beach, VA (US)

(73) Assignee: GENERAL FOAM PLASTICS CORPORATION, Norfolk, VA (US)

(21) Appl. No.: 13/711,163

(22) Filed: Dec. 11, 2012

(51) Int. Cl. E06C 7/00

(52) U.S. Cl. CPC E06C 7/00
USPC 182/129

(57) ABSTRACT

A swimming pool ladder. An exemplary swimming pool ladder configured to hinder occupants of the swimming pool from passing between an interior ladder section and a pool frame, and also to hinder occupants of the swimming pool from passing through the spaces between the steps of the interior ladder section.

### CROSS REFERENCE TO RELATED APPLICATIONS

The present application is related to, and claims the priority benefit of, U.S. Provisional Patent Application Ser. No. 61/576,207 filed Dec. 15, 2011, the contents of which are hereby incorporated in their entirety into the present disclosure.

### BACKGROUND

As is known in the art, aboveground pools generally comprise a circumferential frame that defines the boundary of the pool and serves as a support structure for containing the water in the pool. Various designs for the circumferential frame, constructed from various materials, are well known in the art and are not critical to the present disclosure. For example, some pools are designed such that the frame wall is substantially vertical, while other pools are designed such that the frame wall slopes, with the bottom edge of the frame disposed farther from the center of the pool than the top edge of the frame. Often, a pool liner constructed from vinyl, plastic or other suitable material is attached to the frame at or near the top edge of the frame and extends throughout the interior space defined by the frame. The waterproof nature of the liner acts to contain any water in the pool within this interior space. In other prior art designs, the circumferential frame and liner are formed as a single integral structure.

As the name implies, aboveground pools are situated entirely or primarily above the ground level of the surrounding terrain. In order to facilitate ingress to and egress from the interior space of an aboveground pool, a ladder is provided. Such ladders are typically configured in an A-frame shape, with each of the legs of the A-frame comprising a ladder section having multiple steps. When installed for use, one of the ladder sections is positioned exterior to the pool frame, while the other ladder section is positioned within the interior space of the pool, in the water. The tops of the two ladder sections are joined together at their upper extremities. There are known variations to this arrangement, such as providing a horizontal platform at the top of the ladder joining the two ladder sections, but the general arrangement remains much the same and such variations fall within the scope of the present disclosure.

Because of the shape of ladders for aboveground pools, a space exists between the ladder section positioned in the pool interior space and the pool frame. In many instances, this space is wide enough that it will encourage some persons, especially children, to attempt to swim through this space. Access to this space may be from either side of the interior ladder section or through the spaces between the steps of the interior ladder section. ANSI/APSP-4 entitled “Standard for Aboveground/Onground Residential Swimming Pools” requires that aboveground pool ladders be configured to prevent occupants of the pool from swimming between the interior ladder section and the pool frame, and also to prevent occupants of the pool from swimming through the spaces between the steps of the interior ladder section. The presently disclosed embodiments are directed toward meeting these requirements.

### SUMMARY

In an exemplary embodiment of a swimming pool ladder of the present disclosure, such a swimming pool ladder comprises a first upright in a roughly A-frame configuration, a second upright in a roughly A-frame configuration, a plurality of steps, spaced apart from one another, extending between the first and second uprights to form a first ladder section and a second ladder section, and at least one barrier coupled to at least one of the plurality of steps, the barrier extending away from said at least one step into a space between the first and second ladder sections.

In an exemplary embodiment of a swimming pool ladder of the present disclosure, such a swimming pool ladder comprises a first upright in a roughly A-frame configuration, a second upright in a roughly A-frame configuration, a plurality of steps, spaced apart from one another, extending between the first and second uprights to form a first ladder section and a second ladder section, at least one barrier coupled to at least one of the plurality of steps, the barrier extending away from said at least one step into a space between the first and second ladder sections, and at least one brace extending between said at least one step and said barrier.

In an exemplary embodiment of a swimming pool ladder of the present disclosure, such a swimming pool ladder comprises a first upright in a roughly A-frame configuration, a second upright in a roughly A-frame configuration, a plurality of steps, spaced apart from one another, extending between the first and second uprights to form a first ladder section and a second ladder section, and at least one barrier coupled to at least one of the plurality of steps, the barrier extending away from said at least one step into a space between the first and second ladder sections, wherein said at least one step includes a slot and said at least one barrier includes a tab, said tab being engaged with said slot.

### BRIEF DESCRIPTION OF THE DRAWINGS

The embodiments described herein and other features, advantages and disclosures contained herein, and the manner of attaining them, will become apparent and the present disclosure will be better understood by reference to the following description of various exemplary embodiments of the present disclosure taken in conjunction with the accompanying drawing, wherein:

FIG. 1 shows a perspective view of a first embodiment of a swimming pool ladder;

FIG. 2 shows a perspective view of a second embodiment of a swimming pool ladder;

FIG. 3 shows a perspective view of the first embodiment swimming pool ladder with braces;

FIG. 4 shows a perspective view of the second embodiment swimming pool ladder with braces;

FIG. 5 shows a perspective view of a third embodiment of a swimming pool ladder;

FIG. 6 shows a perspective view of a fourth embodiment of a swimming pool ladder;

FIG. 7 shows a perspective view of the third embodiment swimming pool ladder with braces;

FIG. 8 shows a perspective view of the fourth embodiment swimming pool ladder with braces;

FIG. 9 shows a top perspective view of a first embodiment of a step with a barrier connection slot;

FIG. 10 shows a bottom perspective view of the first embodiment step;

FIG. 11 shows a top perspective view of a barrier being inserted into the first embodiment step;

FIG. 12 shows a close-up view of the barrier being inserted into the first embodiment step;

FIG. 13 shows a top perspective view of the barrier inserted into the first embodiment step;

FIG. 14 shows a bottom perspective view of the barrier inserted into the first embodiment step;

FIG. 15 shows a close-up bottom perspective view of the barrier inserted into the first embodiment step;

FIG. 16 shows a top perspective view of a barrier and braces being inserted into a second embodiment step with a barrier connection slot and brace connection slots;

FIG. 17 shows a bottom perspective view of a barrier and braces being inserted into the second embodiment step;

FIG. 18 shows a perspective view of braces being attached to a barrier;

FIG. 19 shows a perspective view of braces attached to a barrier;

FIG. 20 shows a close-up top perspective view of a brace being inserted into the second embodiment step;

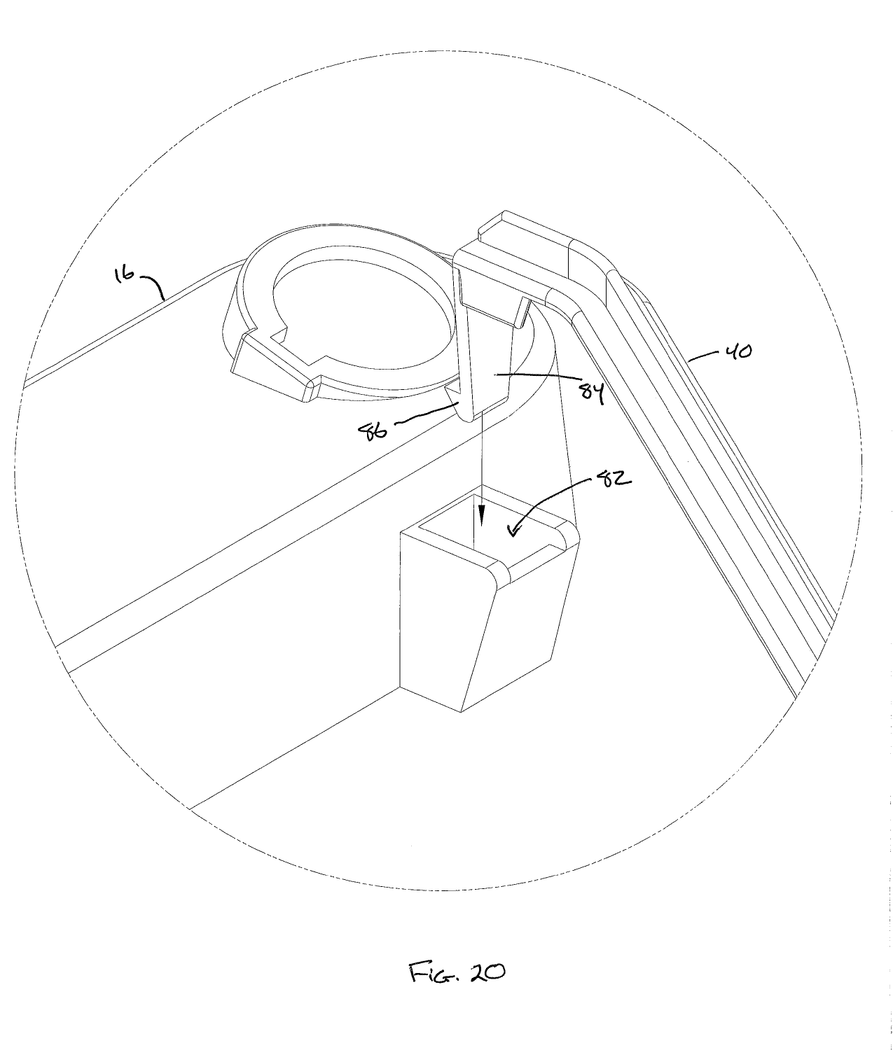

FIG. 21 shows a close-up top perspective view of a brace inserted into the second embodiment step;

FIG. 22 shows a close-up bottom perspective view of a brace inserted into the second embodiment step;

FIG. 23 shows a top perspective view of a barrier and braces inserted into the second embodiment step;

FIG. 24 shows a bottom perspective view of a barrier and braces inserted into the second embodiment step;

FIG. 25 shows a perspective view of a bolt and nut mounted to a ladder upright using washers having contoured surfaces; and

FIG. 26 shows a molded unit having nuts and washers connected thereon.

### DETAILED DESCRIPTION

For the purposes of promoting an understanding of the principles of the present disclosure, reference will now be made to the embodiments illustrated in the drawing, and specific language will be used to describe the same. It should be appreciated that not all of the features of the components of the figure are necessarily described. Some of these non-discussed features, as well as discussed features are inherent from the figures. Other non-discussed features may be inherent in component geometry and/or configuration. It will nevertheless be understood that no limitation of the scope of this disclosure is thereby intended.

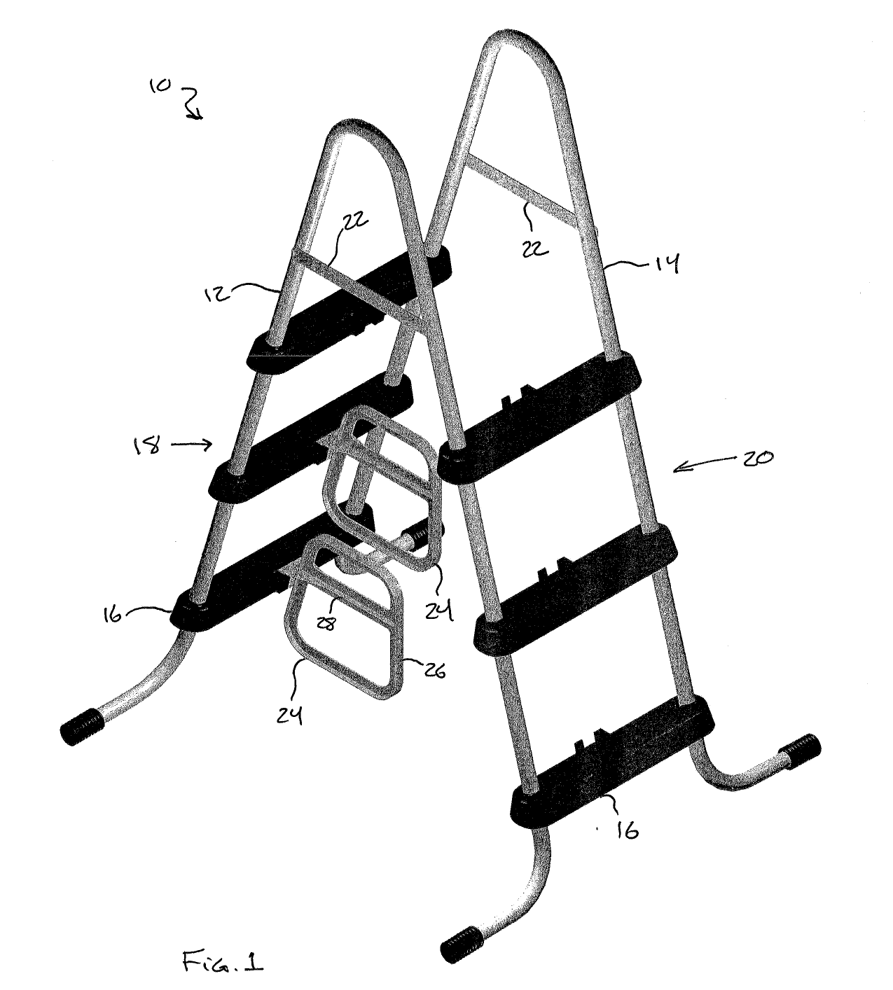

FIG. 1 shows a perspective view of a first embodiment swimming pool ladder according to the present disclosure, indicated generally at 10. Ladder 10 comprises two curved uprights 12, 14 joined together by a plurality of steps 16 spaced apart from each other. When so assembled, the ladder 10 is in the general form of an A-frame and may be positioned over an aboveground pool frame such that inner ladder section 18 is disposed on the inside of the pool in the water, and outer ladder section 20 is disposed on the outside of the pool. Uprights 12, 14 may be formed from any desired material, such as stainless steel or powder coated steel to name just two non-limiting examples. Steps 16 may also be formed from any desired material, such as glass reinforced polypropylene to name just one non-limiting example. Support bars 22 may optionally provide additional rigidity to the structure

The presently disclosed embodiments provide barrier structures that are effective to both prohibit swimming between the inner ladder section 18 and the frame of the pool, and to also prohibit swimming through the spaces between adjacent steps 16. As shown in FIG. 1, barriers 24 are provided for this purpose. As explained in greater detail hereinbelow, in some embodiments the barriers 24 clip to the steps 16, enhancing ease of assembly. Barriers 24 may be formed from any desired material, such as polypropylene or glass reinforced polypropylene to name just two non-limiting examples. In the direction orthogonal to the longitudinal axis of each of the steps 16, the barriers 24 extend away from the inner ladder section 18, thereby physically blocking a substantial portion of the space between the inner ladder section 18 and the pool frame and thus presenting a physical barrier to a person who may try to swim in this space. In this same plane, the barriers 24 extend both above and below each of the steps 16, thereby physically blocking a substantial portion of the space between the steps 16 and thus presenting a physical barrier to a person who may try to swim in this space.

It will be appreciated from FIG. 1 that two similarly sized barriers 24 are coupled to adjacent steps 16 of the ladder 10. The ladder 10 is designed for use with a pool whose frame is substantially vertical. Because the ladder 10 only has three steps 16 in each ladder section, the barriers 24 are sufficient to fill the space between the inner ladder section 18 and the frame.

The barriers 24 illustrated in FIG. 1 comprise a circumferential ring 26 and a crossbar 28. In this configuration, the barriers 24 have substantial openings therein that serve to minimize the amount of material used in their construction and to minimize the resistance presented to the flow of water within the pool; however, after being presented with the disclosure herein those skilled in the art will appreciate that many other configurations and shapes of the barrier 24 are possible while still affording the physical blocking functions described hereinabove.

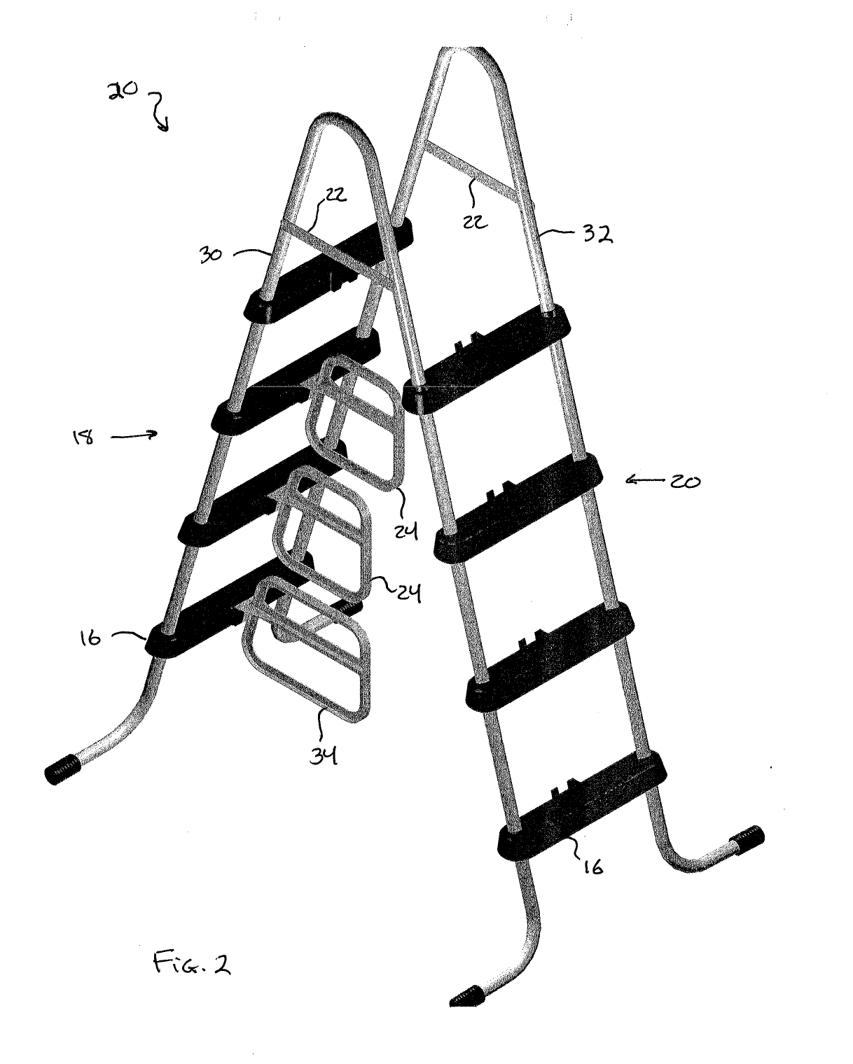

For a pool with a taller vertical frame side, a ladder is illustrated in FIG. 2 and indicated generally at 20. Ladder 20 is very similar to ladder 10; however, it incorporates longer uprights 30, 32 in order to provide an extra step 16 on each of the ladder sections 18, 20. Because the space between the inner ladder section 18 and the pool frame is taller, the ladder 20 utilizes two barriers 24 plus an additional barrier 34. The barrier 34 is similar in design and construction to the barrier 24, but the barrier 34 extends farther away from the step 16 to which it is coupled in order to account for the fact that the bottom of the inner ladder section 18 is farther away from the pool frame than the shorter ladder 10.

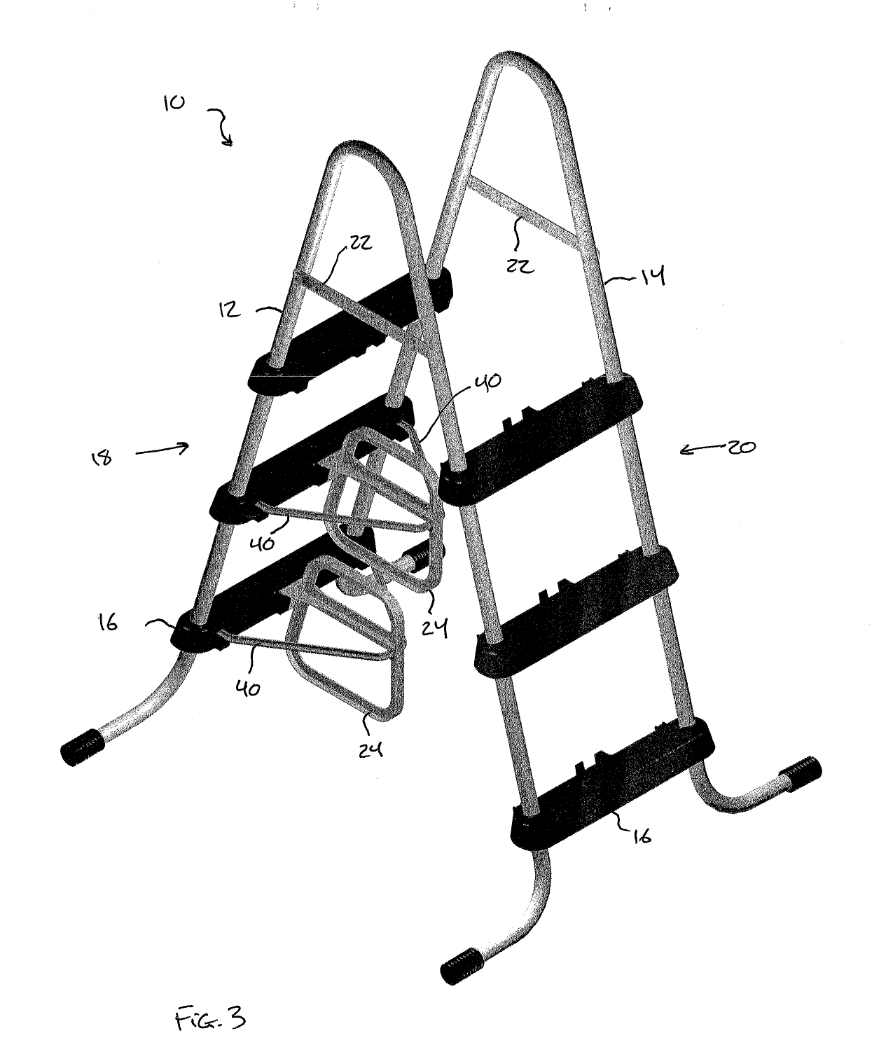

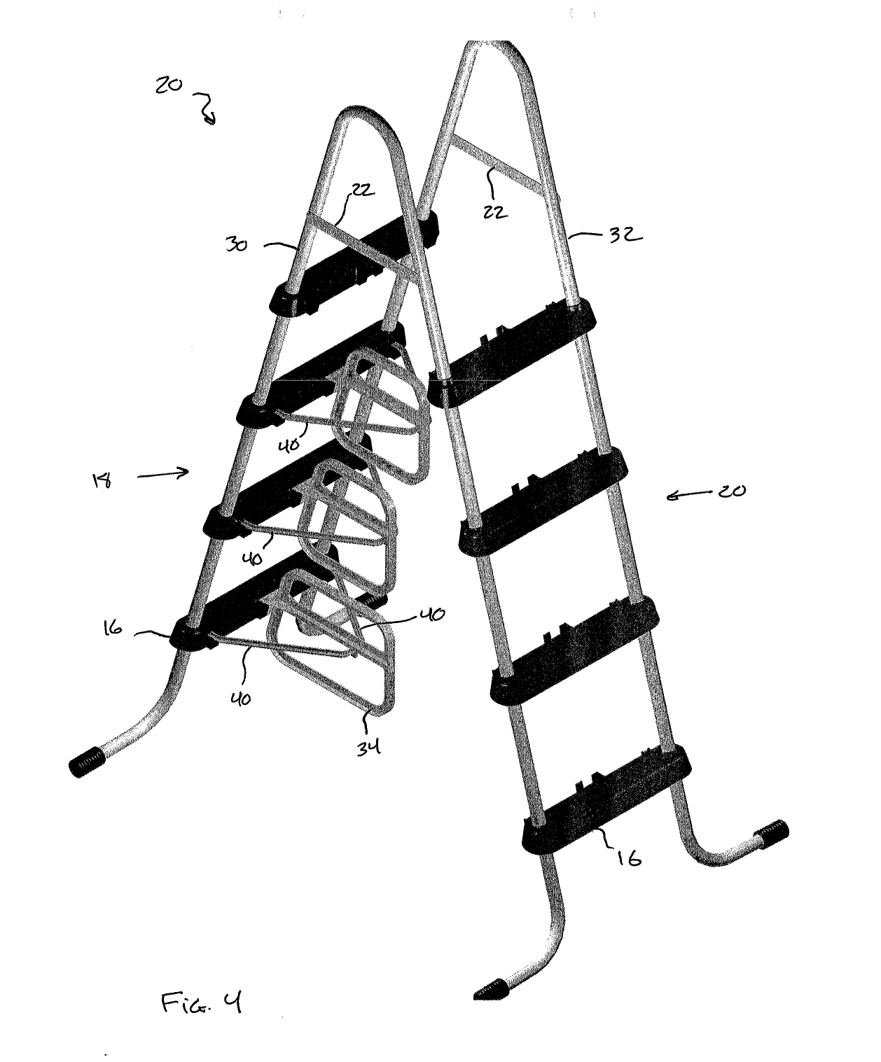

FIG. 3 shows an alternative embodiment of the ladder 10, in which braces 40 extend between the step 16 and the distal portion of the barrier 24. Two such braces are illustrated in FIG. 3 for each barrier 24; however, after being presented with the disclosure herein those skilled in the art will recognize that a greater or fewer number of braces 40 may be employed with each barrier 24. In some embodiments, the braces 40 are made from the same material as the barrier 24, while in other embodiments the braces 40 are made from a different material than the barrier 24. FIG. 4 illustrates the ladder 20 with braces 40 extending between the steps 16 and the barriers 24 and 34. The same brace 40 design may be used for both of the barriers 24 and 34 by simply coupling the brace 40 to the barrier 34 at a point proximal of the distal end of the barrier 34. In other embodiments, a longer brace (not shown) is provided and it is attached at or near the distal end of the barrier 34.

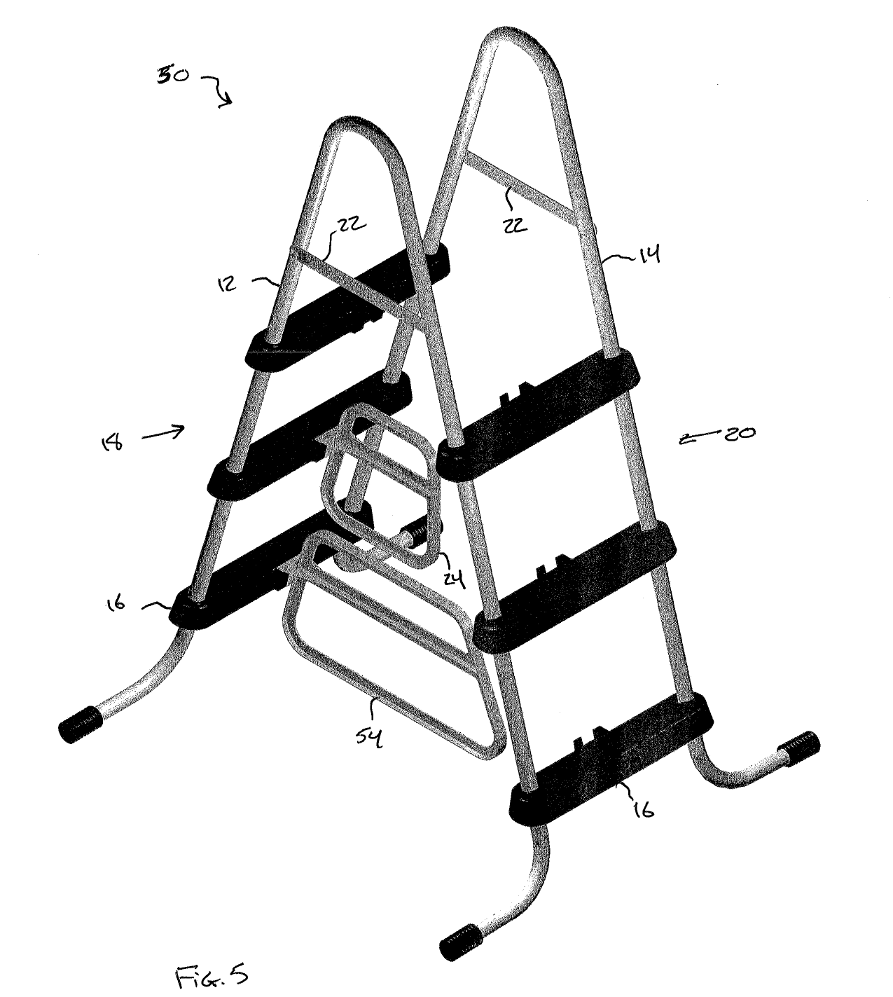

FIG. 5 shows a ladder 50 that is similar to the ladder 10 of FIG. 1; however, the ladder 50 is designed for use with a pool having a sloping frame. The ladder 50 incorporates a barrier 24 attached to the middle step 16. Because of the sloping configuration of the pool frame (not shown), use of a barrier 24 on the bottom step 16 would not extend far enough toward the pool frame to provide the required physical blocking function. Therefore, the ladder 50 incorporates a barrier 54. The barrier 54 is similar in design and construction to the barrier 24, but the barrier 54 extends farther away from the step 16 to which it is coupled in order to account for the fact that the bottom of the inner ladder section 18 is farther away from the pool frame because of the sloping configuration of the pool frame.

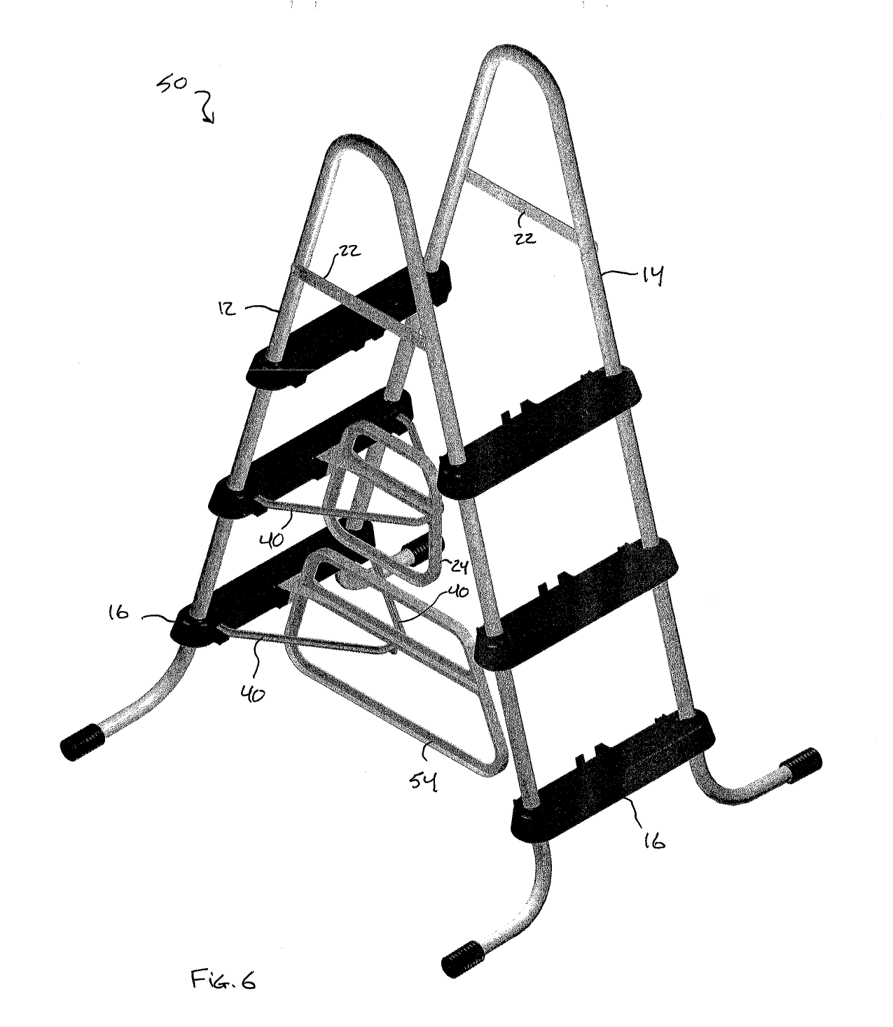

FIG. 6 shows an alternative embodiment of the ladder 50, in which braces 40 extend between the step 16 and the distal portion of the barriers 24, 54. Two such braces are illustrated in FIG. 6 for each of the barriers 24, 54; however, after being presented with the disclosure herein those skilled in the art will recognize that a greater or fewer number of braces 40 may be employed with each of the barriers 24, 54. In some embodiments, the braces 40 are made from the same material as the barriers 24, 54, while in other embodiments the braces 40 are made from a different material than the barriers 24, 54. The same brace 40 design may be used for both of the barriers 24 and 54 by simply coupling the brace 40 to the barrier 54 at a point proximal of the distal end of the barrier 54. In other embodiments, a longer brace (not shown) is provided and it is attached at or near the distal end of the barrier 54.

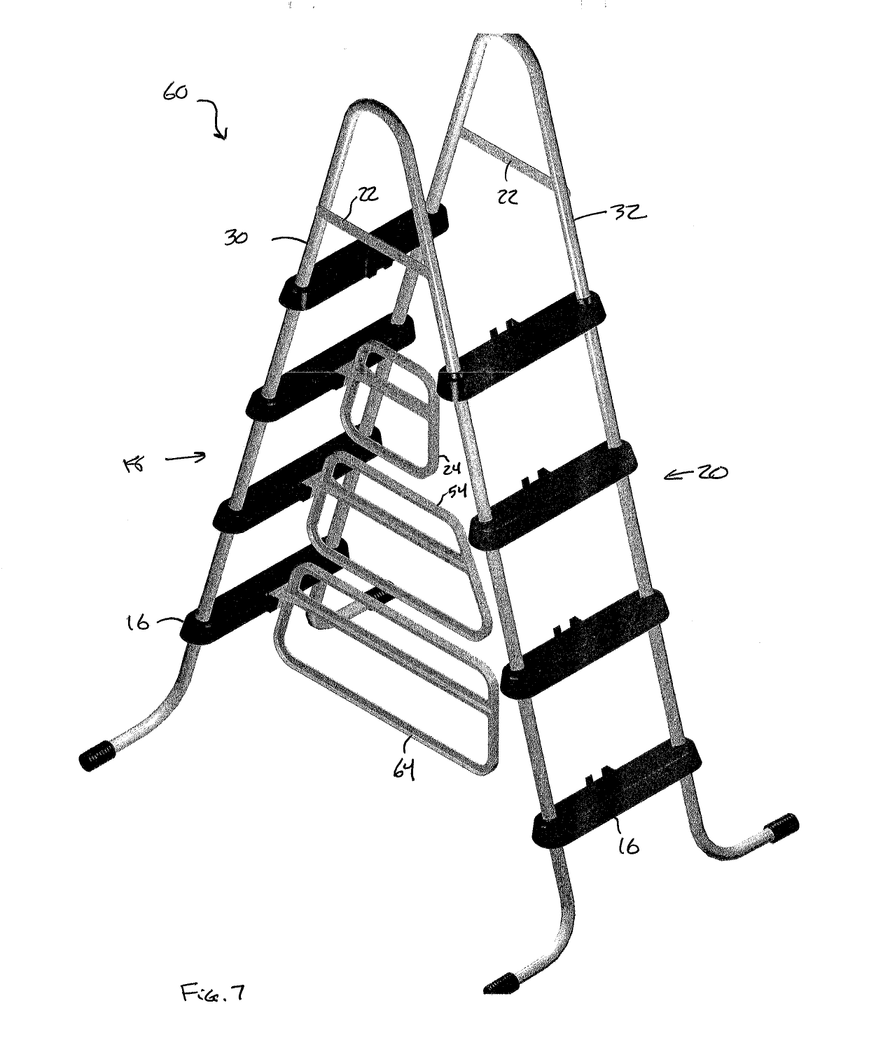

FIG. 7 shows a ladder 60 that is similar to the ladder 20 of FIG. 4; however, the ladder 60 is designed for use with a pool having a sloping frame. The ladder 60 incorporates a barrier 24 attached to the second step 16 from the top of the inner ladder section 18. Because of the sloping configuration of the pool frame (not shown), use of a barrier 24 on the third step 16 from the top would not extend far enough toward the pool frame to provide the required physical blocking function. Therefore, the ladder 60 incorporates a barrier 54 at this location. Similarly, use of a barrier 24 or 54 on the bottom step 16 would not extend far enough toward the pool frame to provide the required physical blocking function. Therefore, the ladder 60 incorporates a barrier 64 at this location. The barrier 64 is similar in design and construction to the barriers 24, 54, but the barrier 64 extends farther away from the step 16 to which it is coupled in order to account for the fact that the bottom of the inner ladder section 18 is farther away from the pool frame because of the sloping configuration of the pool frame.

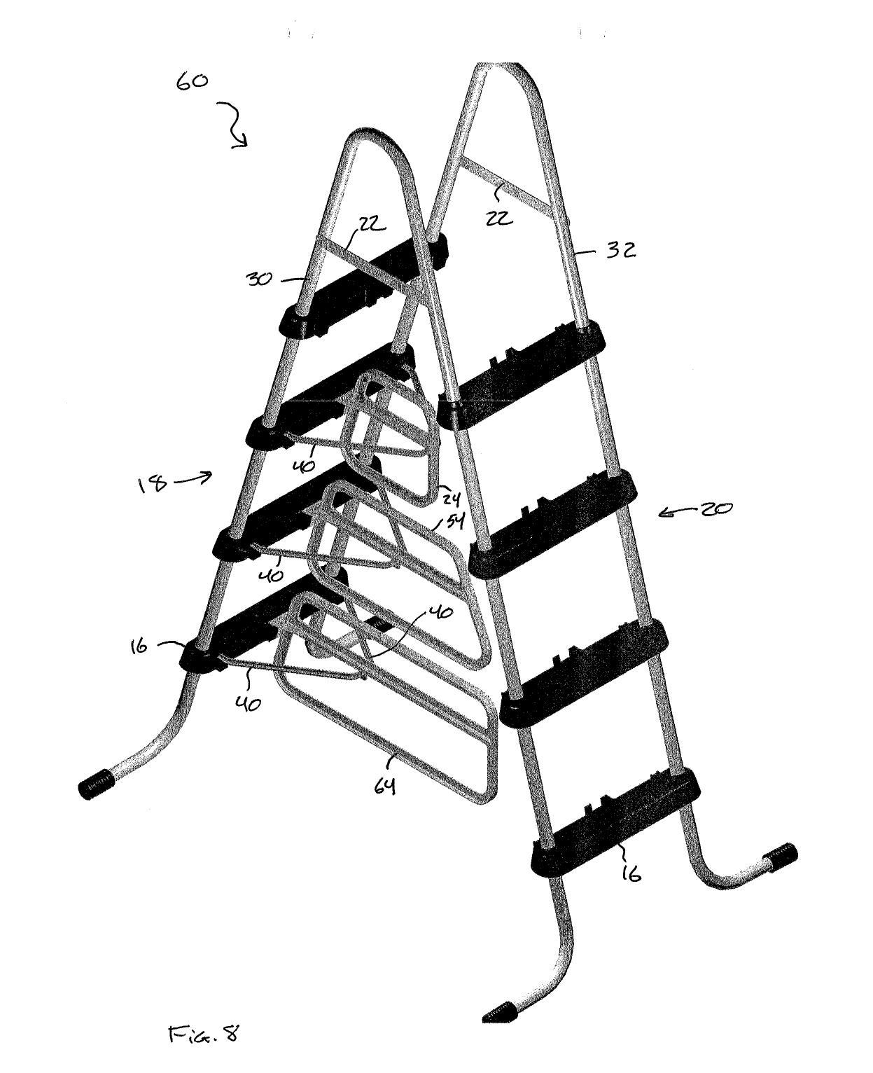

FIG. 8 shows an alternative embodiment of the ladder 60, in which braces 40 extend between the step 16 and the distal portion of the barriers 24, 54, 64. Two such braces are illustrated in FIG. 8 for each of the barriers 24, 54, 64; however, after being presented with the disclosure herein those skilled in the art will recognize that a greater or fewer number of braces 40 may be employed with each of the barriers 24, 54, 64. In some embodiments, the braces 40 are made from the same material as the barriers 24, 54, 64, while in other embodiments the braces 40 are made from a different material than the barriers 24, 54, 64. The same brace 40 design may be used for each of the barriers 24, 54, 64 by simply coupling the brace 40 to the barriers 54, 64 at a point proximal of the distal end of the barriers 54, 64. In other embodiments, longer braces (not shown) are provided and they are attached at or near the distal end of the barriers 54, 64.

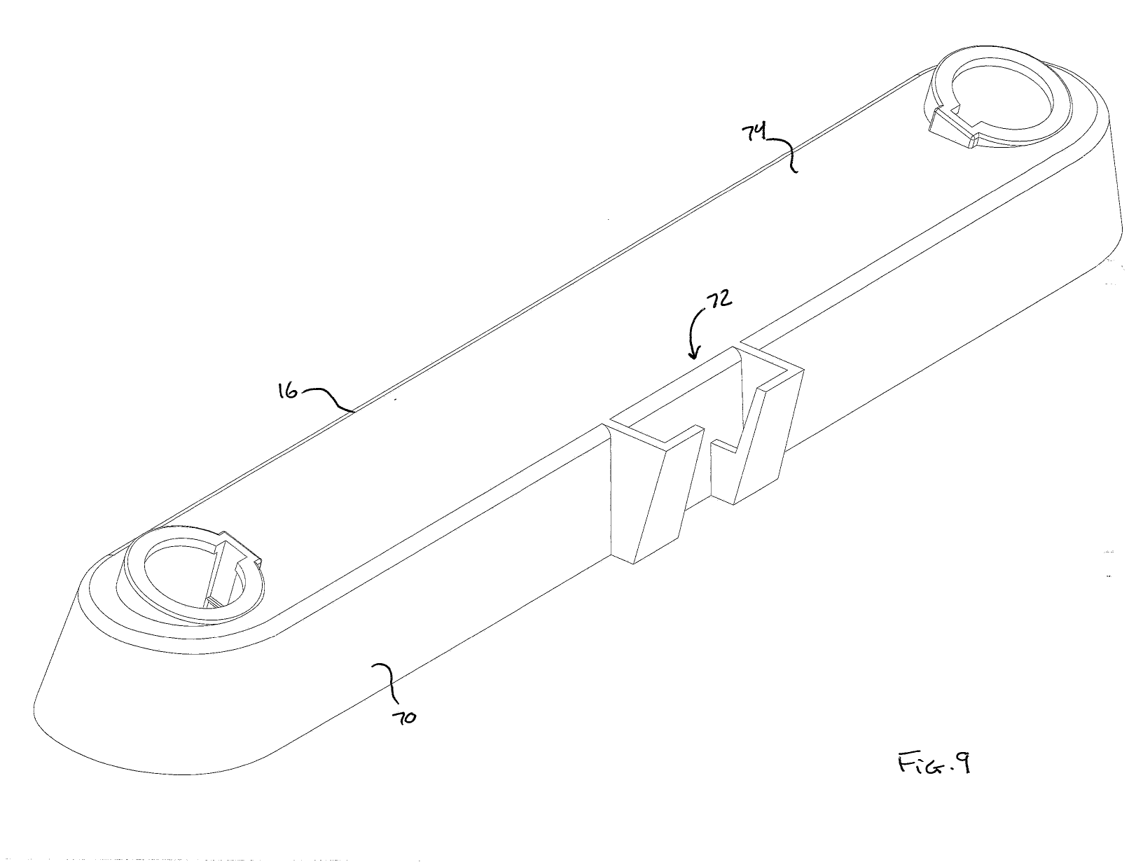

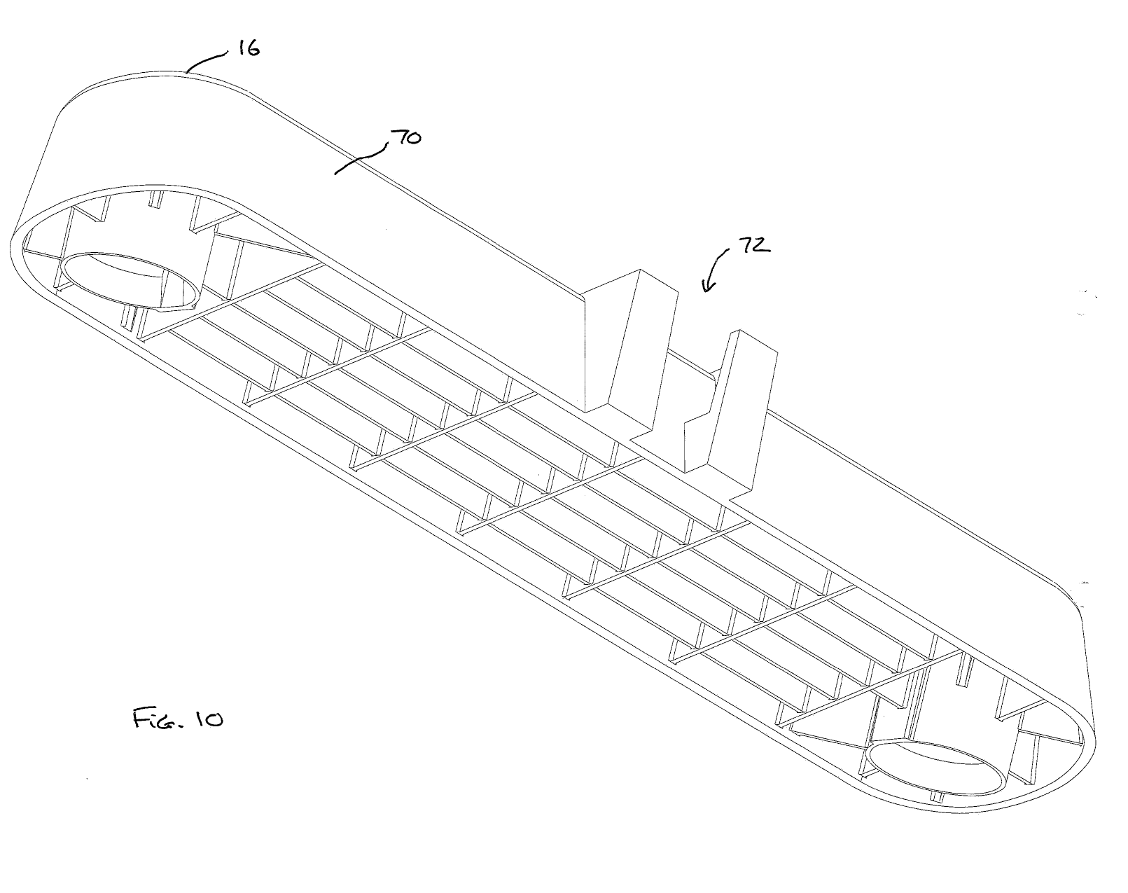

FIGS. 9 and 10 show one embodiment of the step 16 which provides for convenient attachment of any of the barriers 24, 34, 54, 64 thereto. The inner face 70 of the step 16 that faces the pool frame is provided with a slot 72 that extends away from the face 70 in order to preserve the surface area of the tread surface 74 of the step 16. In other embodiments, the structure of the slot 72 extends into the tread surface 74.

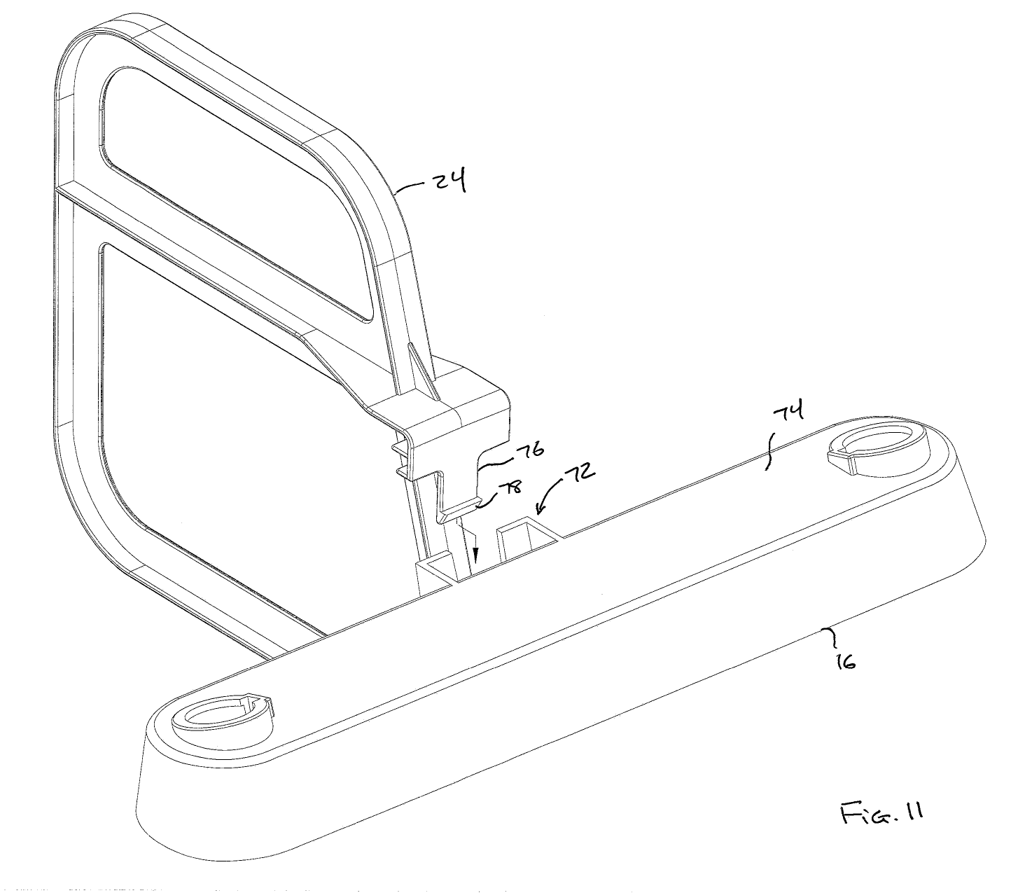

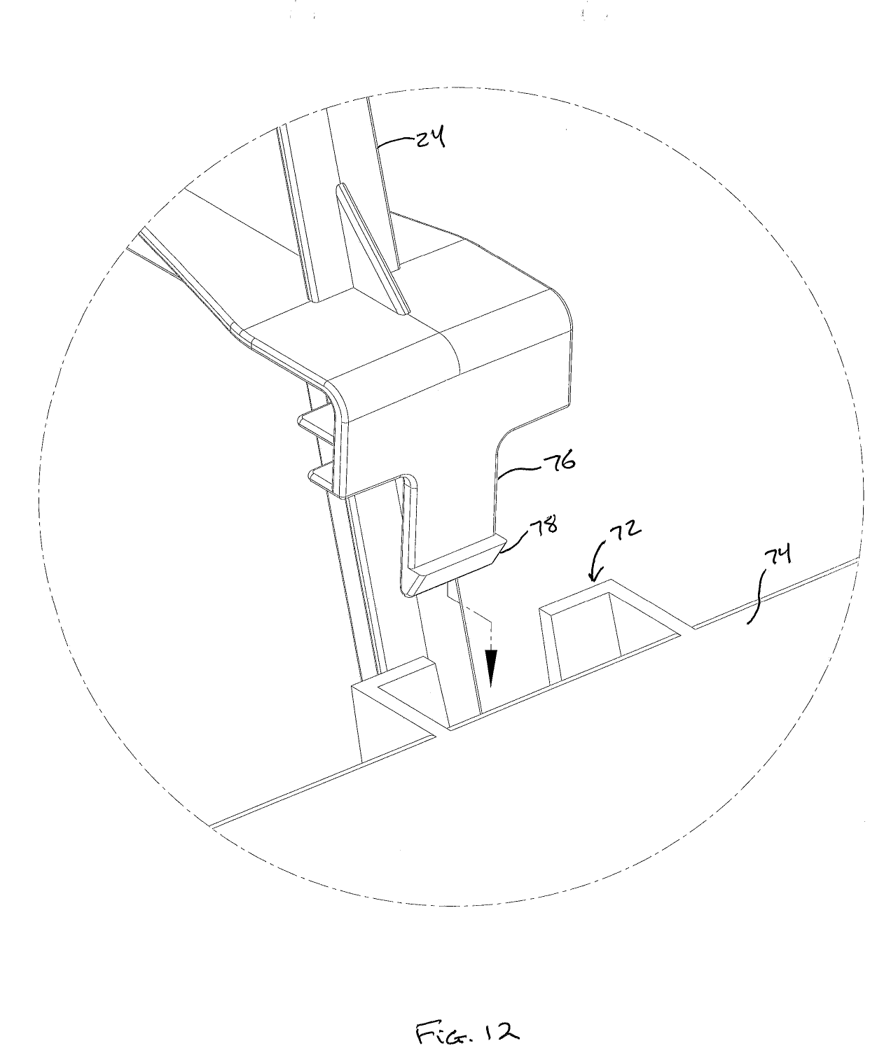

FIGS. 11 and 12 show a barrier 24 being inserted into the slot 72. The barrier 24 includes a tab 76 extending therefrom. Engagement of the tab 76 with the slot 72 holds the barrier 24 in place on the step 16. Barriers having other configurations, such as the barriers 54 and 64, may be provided with the same tab 76 arrangement. This allows all of the steps 16 to be manufactured to the same design so that different steps do not have to be inventoried in order to accommodate the different barrier designs.

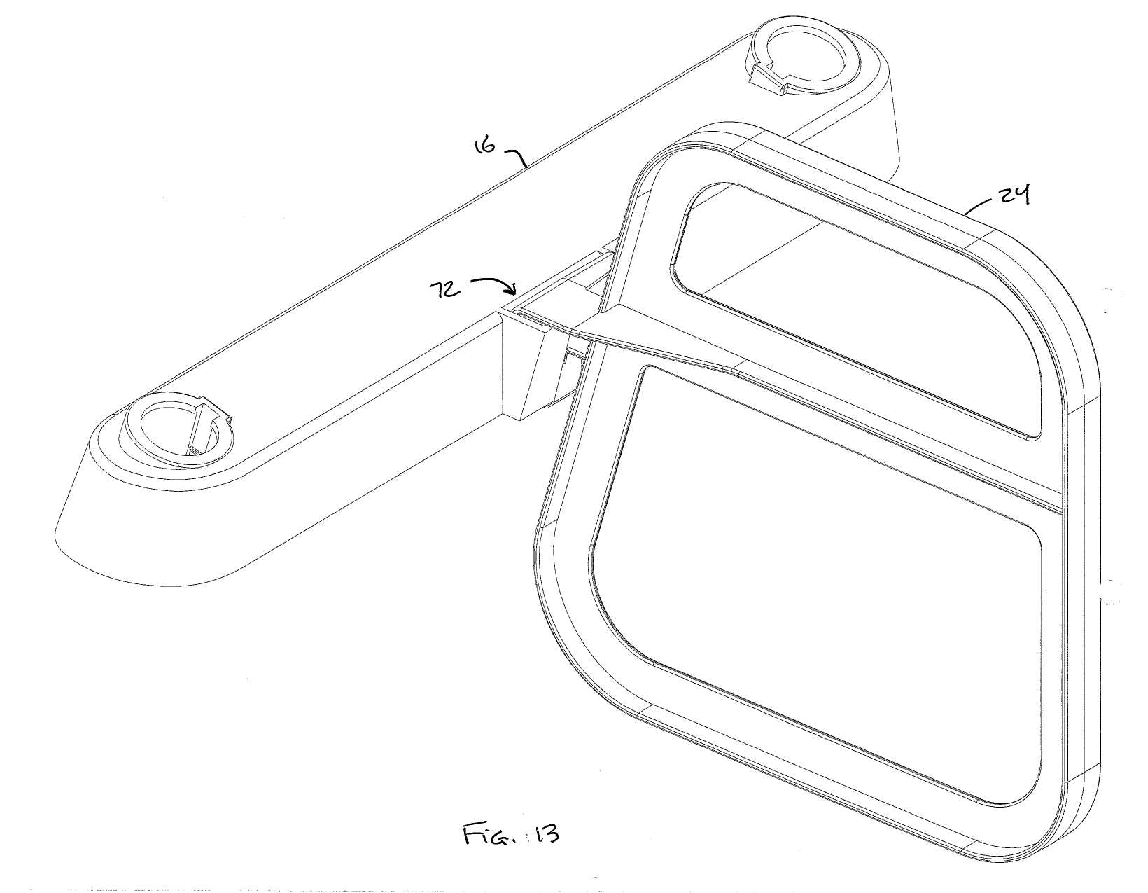

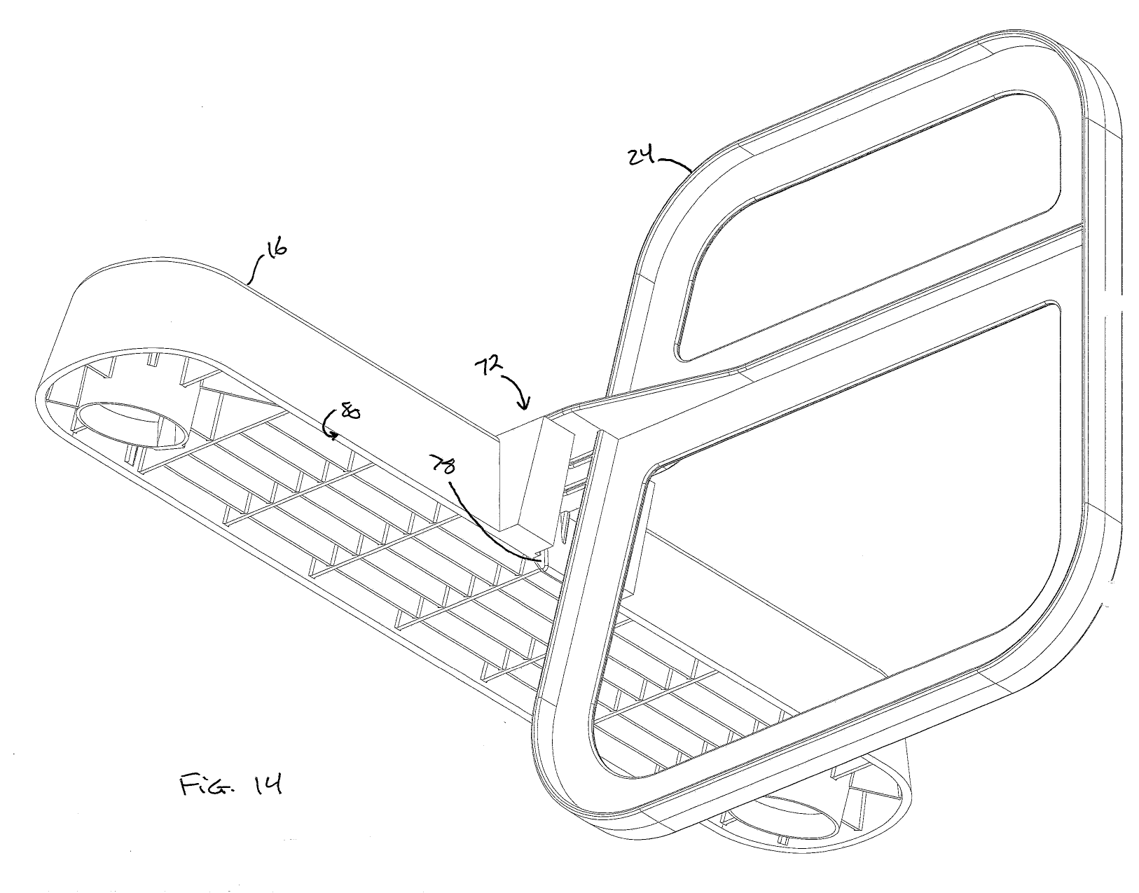

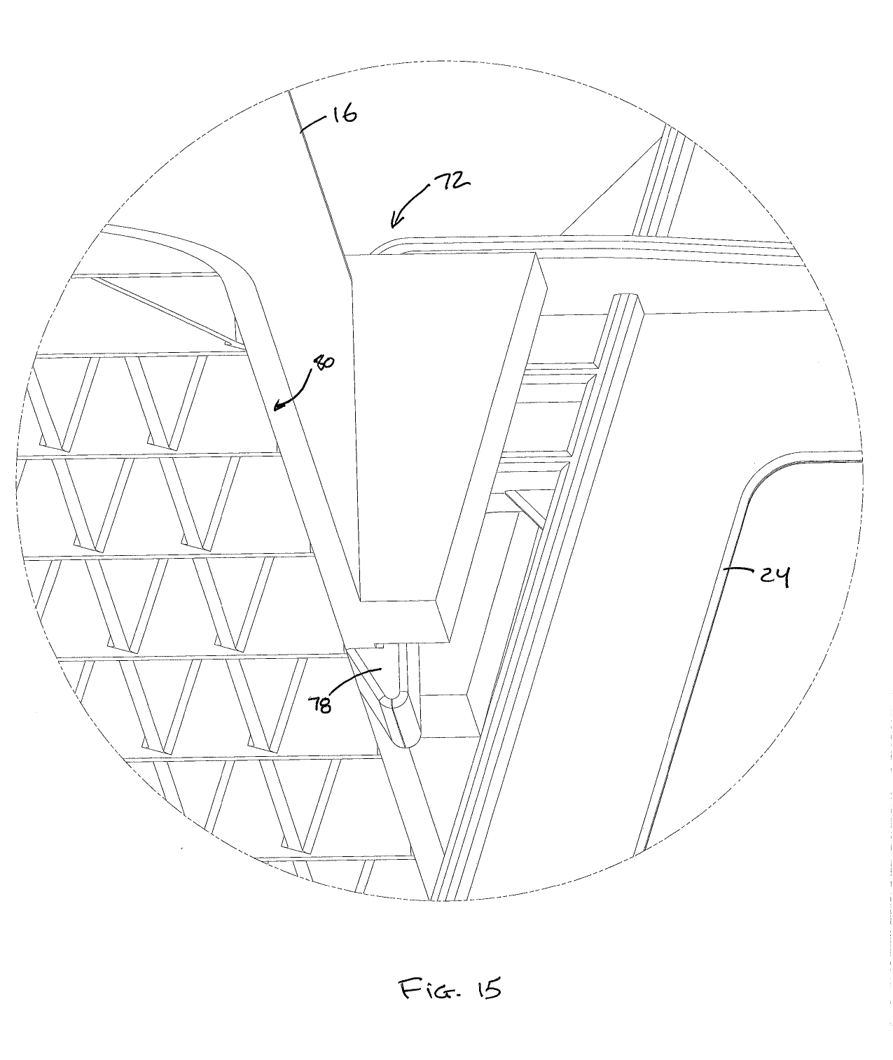

In some embodiments, the tab 76 includes a tang 78 at or near the distal end thereof. The tang 78 serves to lock the barrier in place once the tab 76 has been fully inserted into the slot 72. FIGS. 13 and 14 show the barrier 24 fully engaged with the step 16. FIGS. 14 and 15 show the tang 78 engaged with the step 16 by extending over the bottom lip 80 of the step 16.

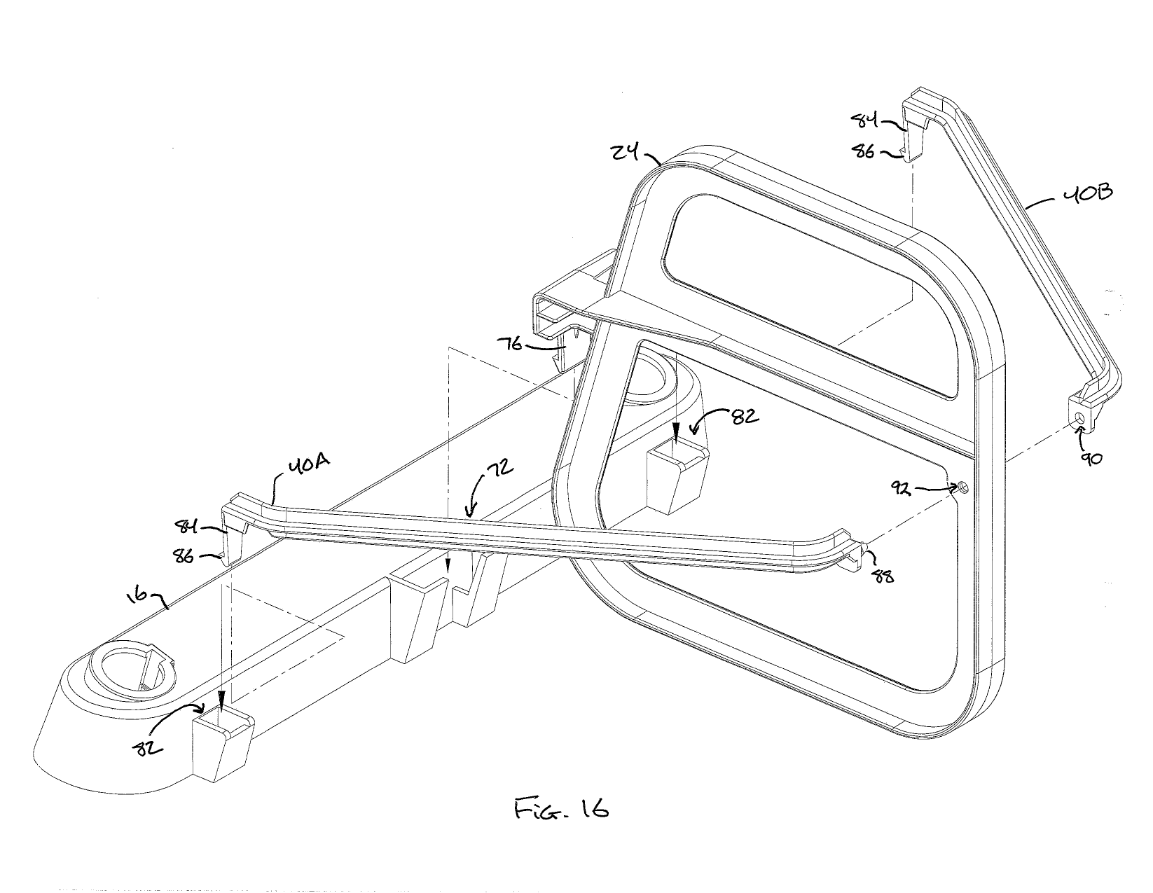

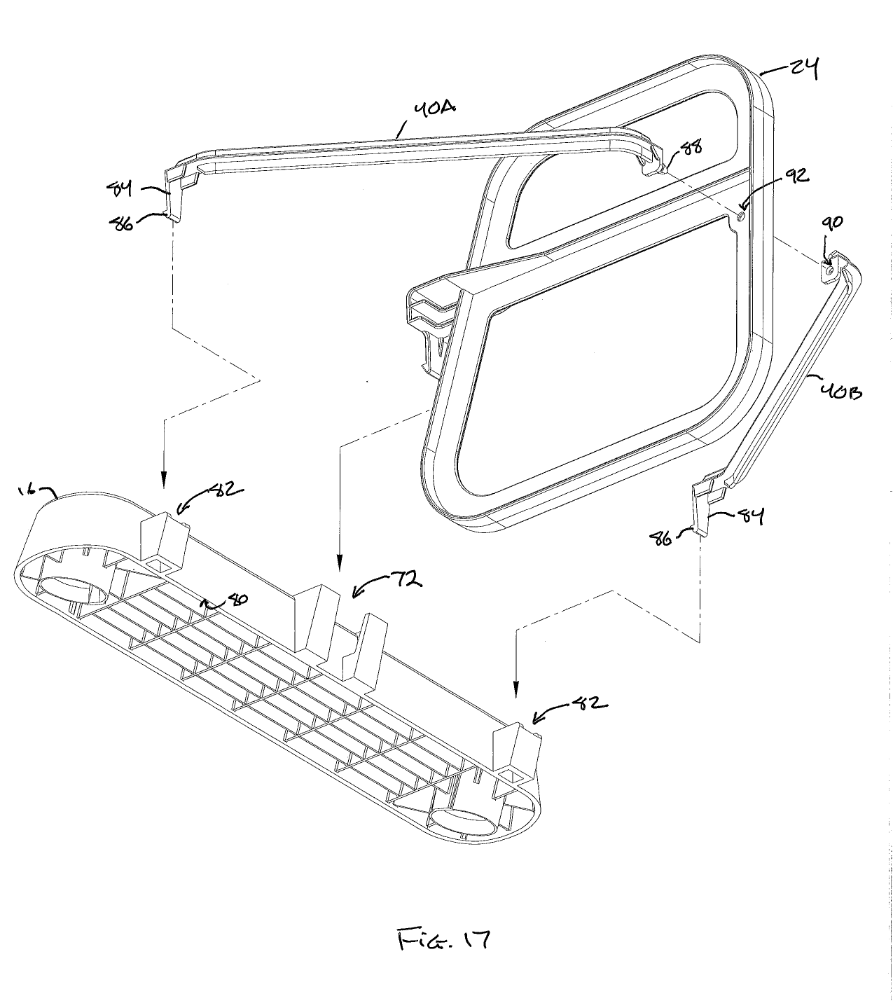

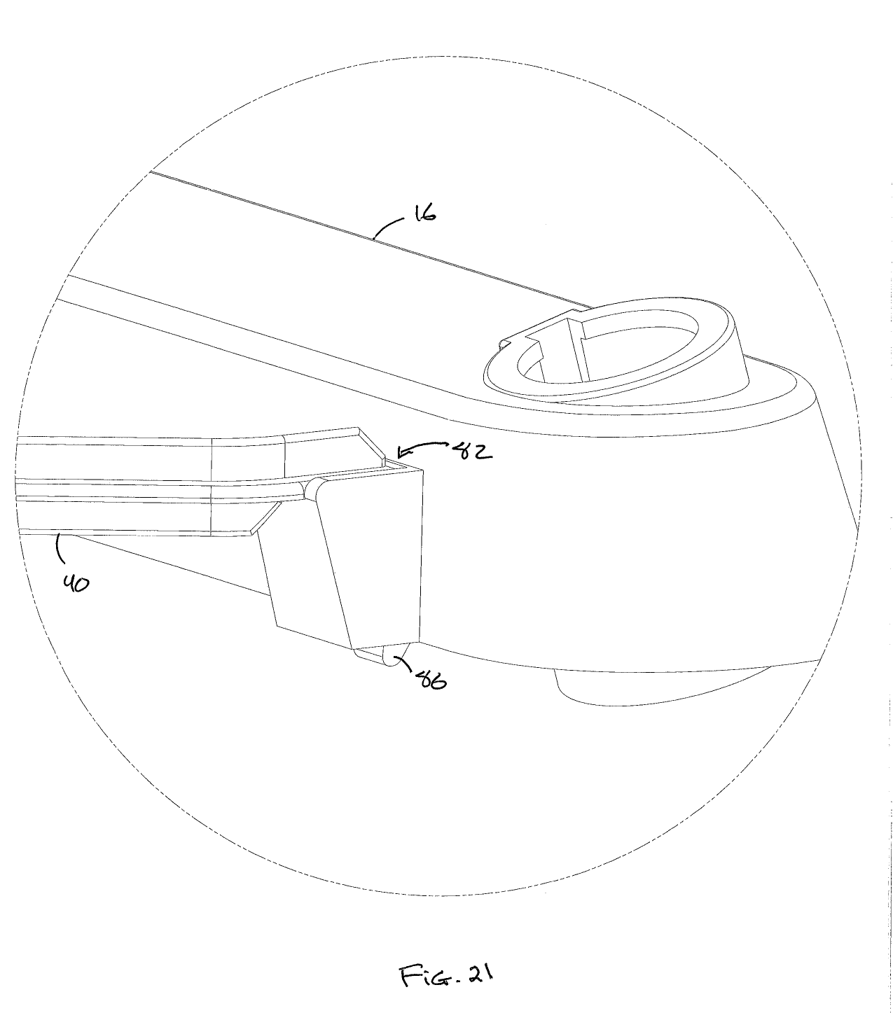

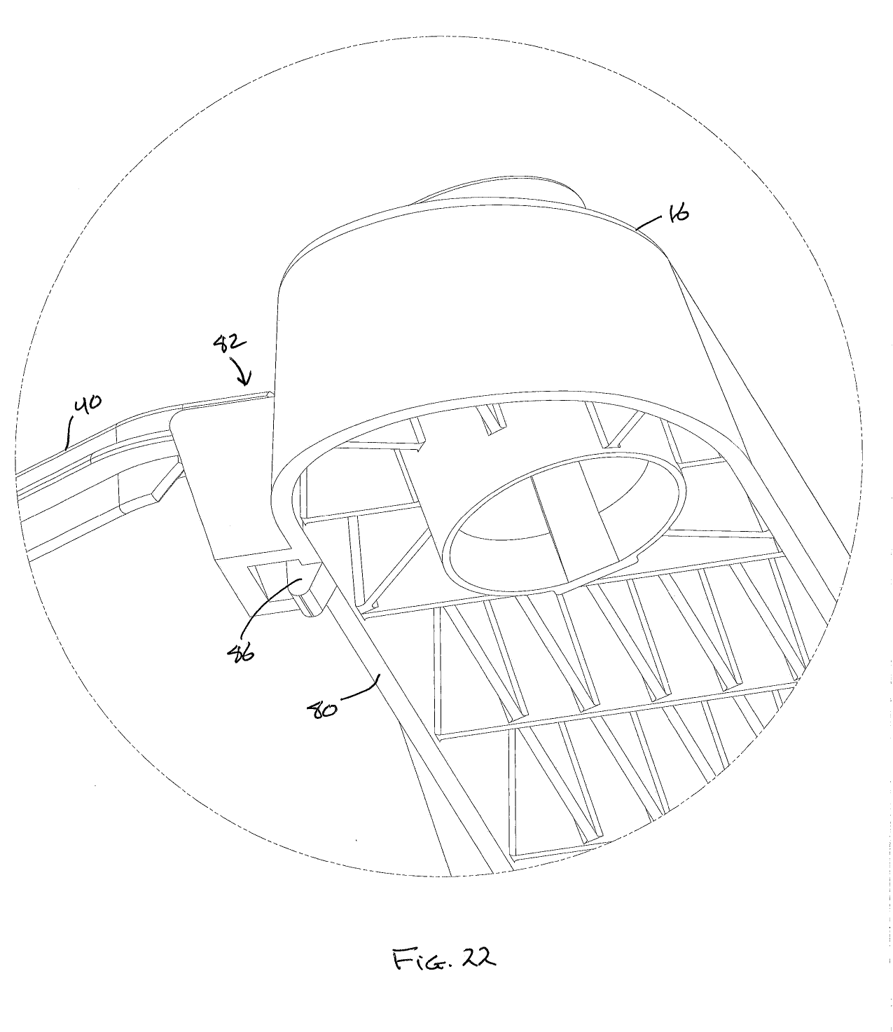

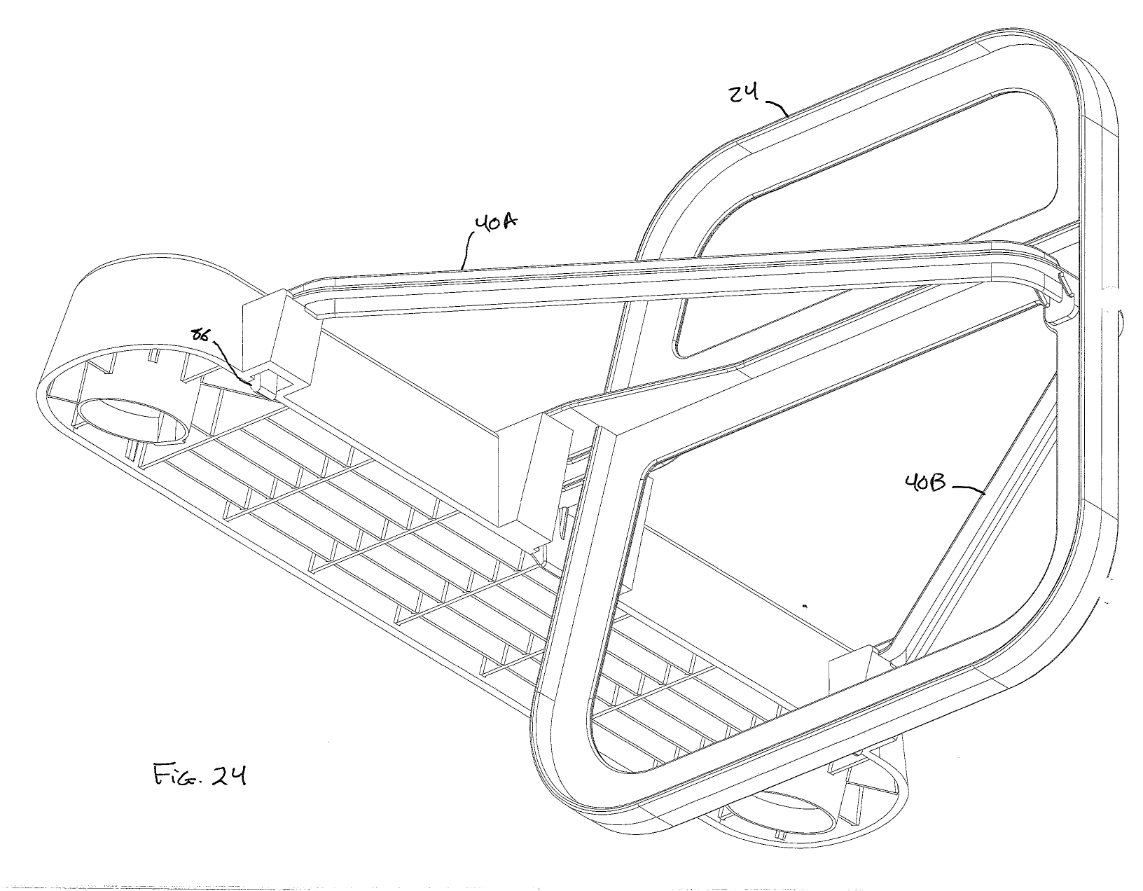

FIGS. 16 and 17 show one embodiment of the attachment of the braces 40 to the step 16. The step 16 may be provided with a slot 82 for each brace 40 to be attached to the step 16. The slot 82 receives a tab 84 on the proximal end of the brace 40 in order to secure the brace 40 to the step 16. In some embodiments, the tab 84 includes a tang 86 that extends over the bottom lip 80 of the step 16 as shown in FIGS. 21, 22 and 24.

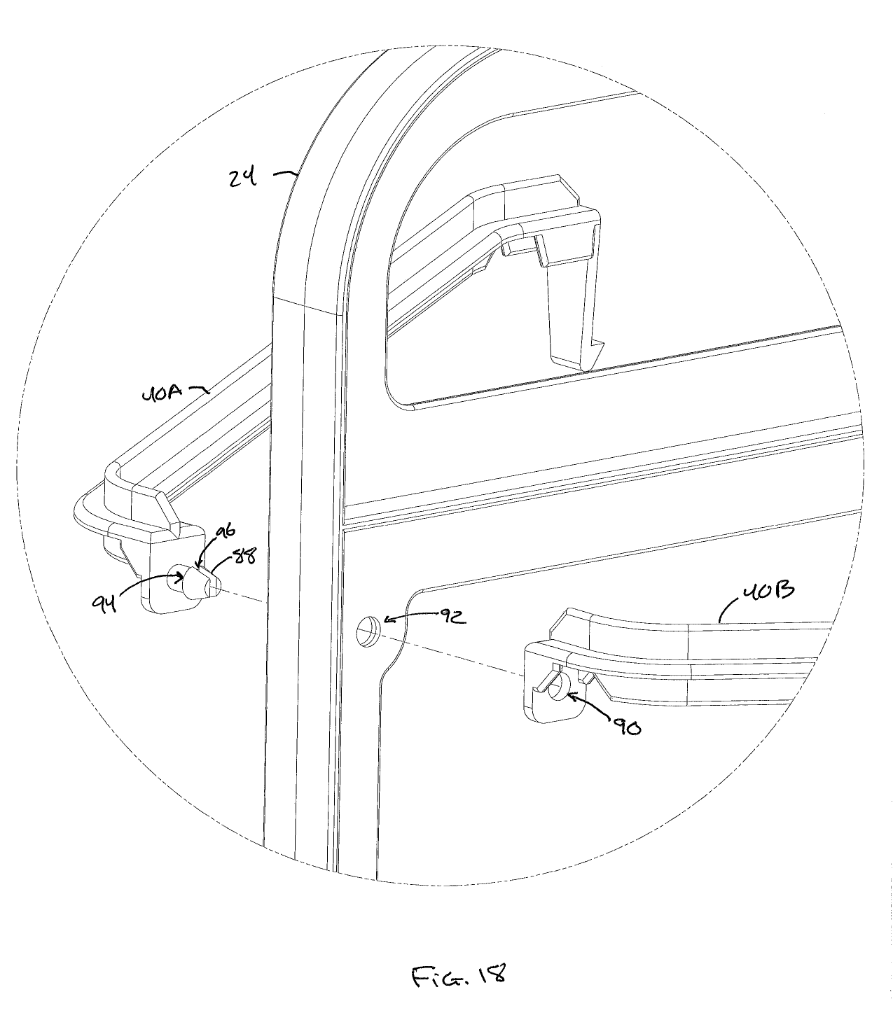

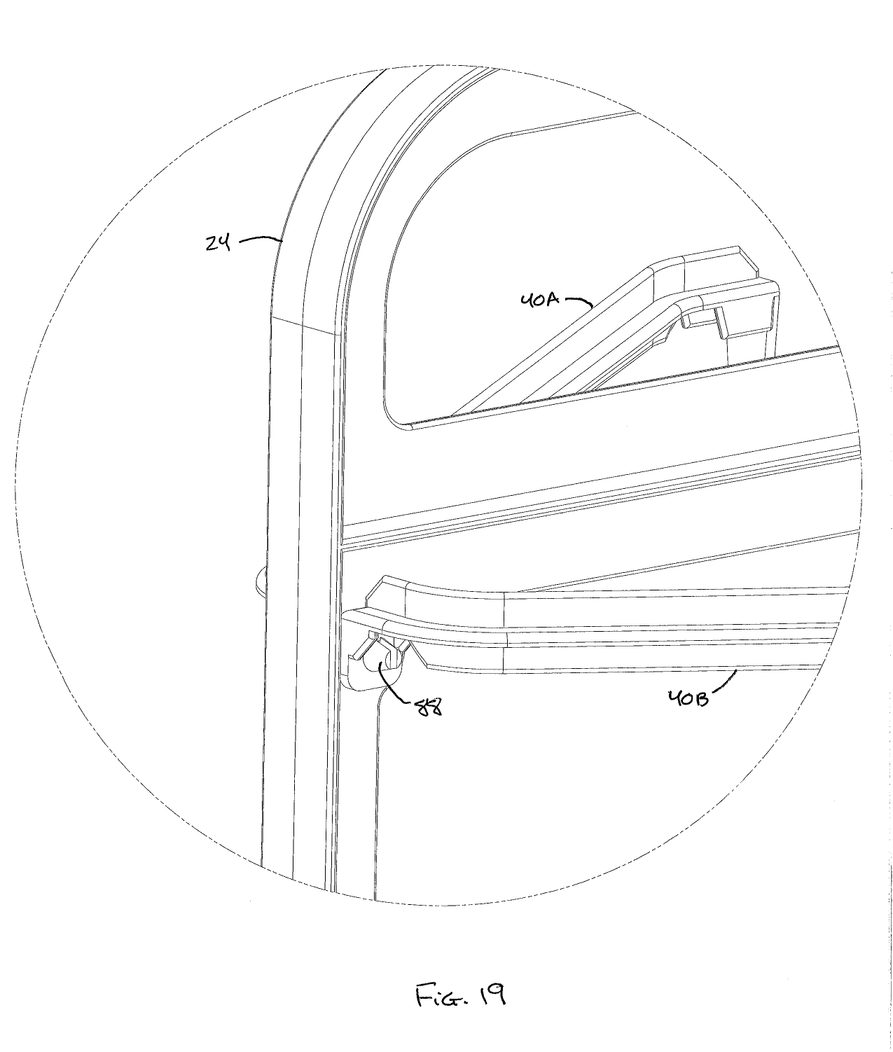

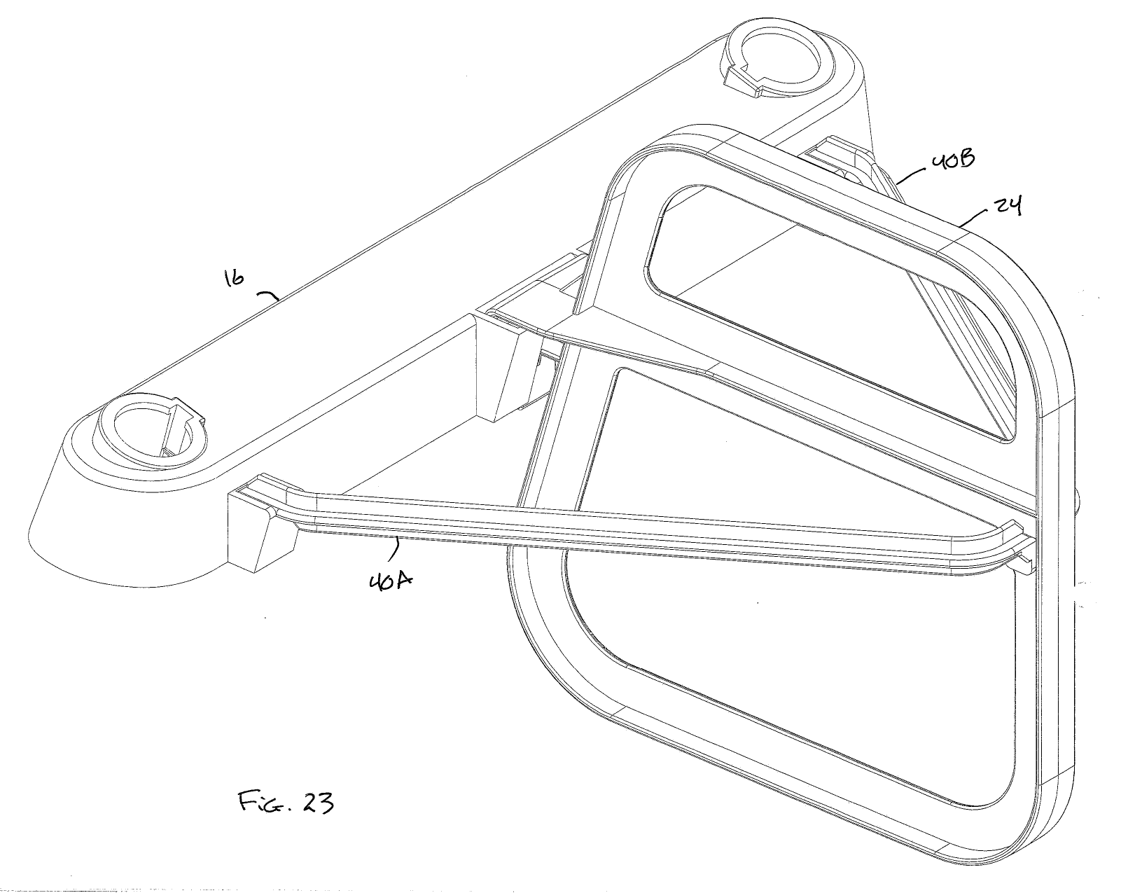

FIGS. 16-19 show one embodiment of the attachment of the braces 40 to the barrier 24, 34, 54, 64 (barrier 24 is illustrated by way of example). One of the braces 40A is provided with a deformable protrusion 88 at the distal end thereof, which mates with an aperture 90 at the distal end of the second brace 40B. A second aperture 92 is provided in the barrier 24 to allow the protrusion 88 to pass therethrough. The protrusion 88 includes a frustoconical shape that defines a ridge 94. The braces 40A and 40B are mated by guiding the protrusion through the aperture 92 in the barrier 24 and then through the aperture 90 in the brace 40B. The aperture 90 is sized such that the frustoconical portion 88 is compressed, such as by squeezing shut the gap 96. Once the ridge 94 exits the far side of the aperture 90, pressure is released on the protrusion 88 and it returns to its original size and configuration. This makes the ridge 94 greater in diameter than the aperture 90, thereby retaining the protrusion 88 on the far side of the aperture 90, locking the braces 40A and 40B together, as shown in FIG. 19. FIG. 23 shows the braces 40A and 40B fully mounted to the step 16 and the barrier 24.

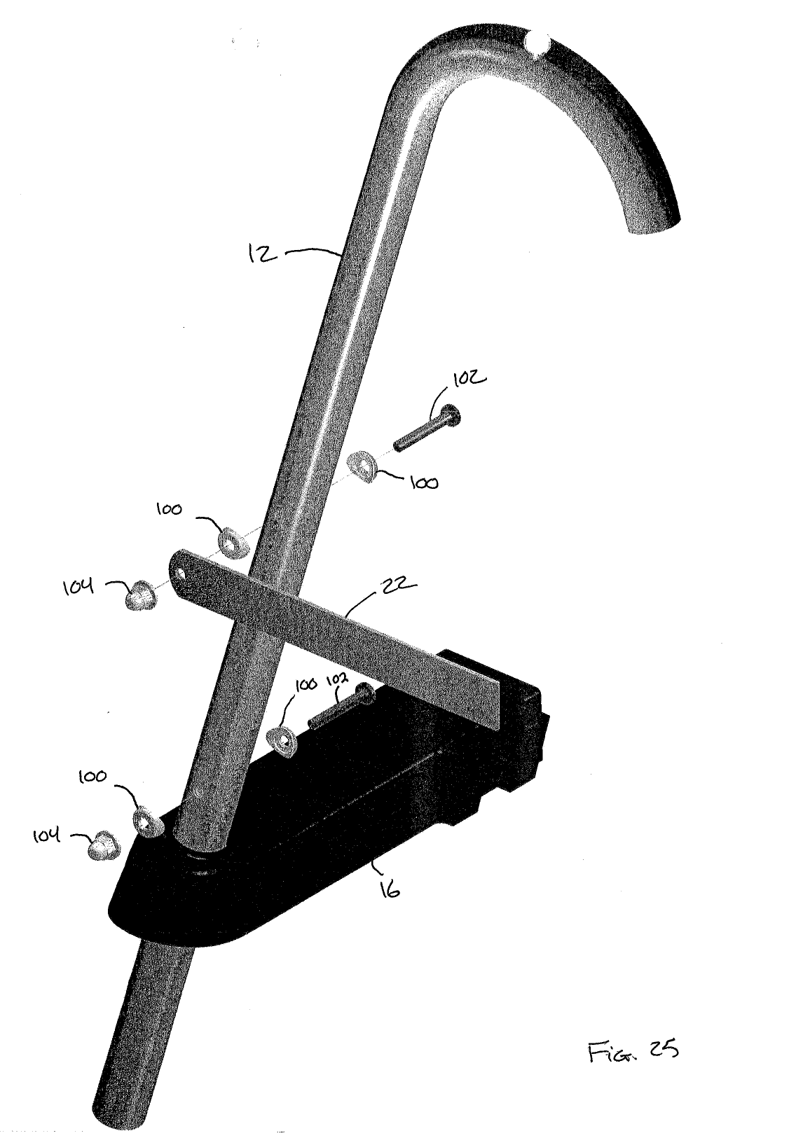

In one embodiment, items coupled to the uprights 12, 14 (or uprights 30, 32) may be secured by the use of contoured plastic washers that mate with the curved surface of the uprights 12, 14. As shown in FIG. 25, one side of washers 100 is contoured to match the curvature of the upright's curved surface. The washers 100 may be formed from any appropriate material, and a form of plastic material may be used, for example. A washer 100 is placed on either side of the upright 12, 14 and a bolt 102 is passed therethrough. The distal end of the bolt is secured by a nut 104. The nut 104 may be formed from any appropriate material, and a form of plastic material may be used, for example.

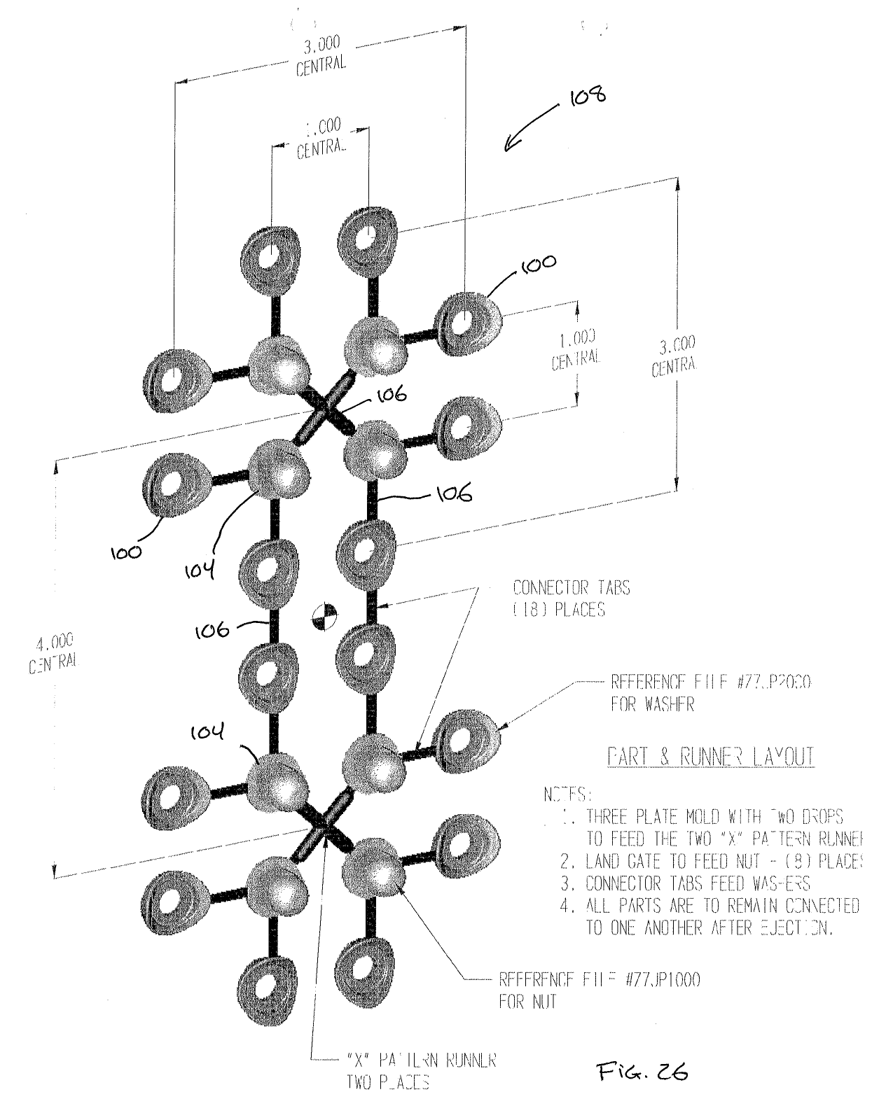

As shown in FIG. 26, the washers 100 and nuts 104 may be formed from the same plastic material and molded together in any appropriate process, such as by injection molding to name just one non-limiting example. As is known in the art, the paths in the mold will leave plastic connector tabs 106 coupling each of the washers 100 and nuts 104 to their nearest neighbors. In order to conveniently provide the needed quantity of washers 100 and nuts 104 for eventual final assembly of the ladder, the tabs 106 may be left in place so that the entire molded unit, indicated generally at 108, may be packaged with the other parts of the ladder to be assembled at a later time.

While this disclosure has been described as having a preferred design, the systems and methods according to the present disclosure can be further modified within the scope and spirit of this disclosure. This application is therefore intended to cover any variations, uses, or adaptations of the disclosure using its general principles. For example, the methods disclosed herein and in the appended claims represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains and which fall within the limits of the appended claims.

What is claimed is:

1. A pool ladder comprising:
a first upright in a roughly A-frame configuration;
a second upright in a roughly A-frame configuration;
a plurality of steps, spaced apart from each other, extending between said first and second uprights to form a first ladder section and a second ladder section and
at least one barrier coupled to at least one of said steps, said at least one barrier extending away from said at least one step into a space between said first and second ladder sections, wherein each said barrier is coupled to only one step.

2. The pool ladder of claim 1, wherein at least one of said plurality of steps includes at least one slot that extends away from a face of said step.

3. The pool ladder of claim 1, wherein said at least one barrier comprises a tab extending therefrom.

4. The pool ladder of claim 3, wherein said tab further comprises a tang at or near a distal end thereof.

5. A pool ladder comprising:
a first upright in a roughly A-frame configuration;
a second upright in a roughly A-frame configuration;
a plurality of steps, spaced apart from each other, extending between said first and second uprights to form a first ladder section and a second ladder section;
at least one barrier coupled to at least one of said steps, said at least one barrier extending away from said at least one step into a space between said first and second ladder sections; and
at least one brace extending between said at least one step and said barrier.

6. The pool ladder of claim 5, wherein at least one of said plurality of steps includes at least one slot that extends away from a face of said step.

7. The pool ladder of claim 5, wherein said at least one barrier includes a tab extending therefrom and an aperture located proximal to a distal end of said at least one barrier.

8. The pool ladder of claim 7, wherein said tab further comprises a tang at or near a distal end thereof.

9. The pool ladder of claim 5, wherein said at least one brace comprises:
a first brace member, said first brace member comprising a tab located at a proximal end of said first brace member and a deformable protrusion located at a distal end of said first brace member; and
a second brace member said second brace member comprising a tab located at a proximal end of said second brace member and an aperture located at a distal end of said second brace member;
wherein said deformable protrusion of said first brace member passes through an aperture of said barrier and engages with said aperture of said second brace member; and
wherein said tab of said first brace member engages at least one slot of one of said plurality of steps; and
wherein said tab of said second brace member engages at least one slot of one of said plurality of steps.

10. A pool ladder comprising:
a first upright in a roughly A-frame configuration;
a second upright in a roughly A-frame configuration;
a plurality of steps, spaced apart from each other, extending between said first and second uprights to form a first ladder section and a second ladder section, and;
at least one barrier coupled to at least one of said steps, said at least one barrier extending away from said at least one step into a space between said first and second ladder sections, wherein each said barrier is coupled to only one step, and wherein said at least one step includes a slot and said at least one barrier includes a tab, said tab being engaged with said slot.

11. The pool ladder of claim 10, wherein said tab further comprises a tang at or near a distal end thereof.
